(19) United States
(12) Patent Application Publication
(10) Pub. No.: US 2025/0182739 A1
(43) Pub. Date: Jun. 5, 2025

(54) APPARATUS AND METHOD FOR END-TO-END TEXT-TO-SPEECH SYNTHESIS

(71) Applicant: Sony Group Corporation, Tokyo (JP)

(72) Inventors: Bac NGUYEN CONG, Stuttgart (DE); Fabien CARDINAUX, Stuttgart (DE); Stefan UHLICH, Stuttgart (DE)

(73) Assignee: Sony Group Corporation, Tokyo (JP)

(21) Appl. No.: 18/844,052

(22) PCT Filed: Mar. 7, 2023
(86) PCT No.: PCT/EP2023/055656

§ 371 Date: Sep. 5, 2024

(30) Foreign Application Priority Data
Mar. 18, 2022 (EP) 22162999.1

(51) Int. Cl. G10L 13/08; G10L 13/027

(52) U.S. Cl. CPC G10L 13/08; G10L 13/027

(57) ABSTRACT

An apparatus for end-to-end text-to-speech synthesis is provided. The apparatus comprises input interface circuitry configured to receive first input data indicative of a phoneme and second input data indicative of a first target duration for the phoneme. The apparatus further comprises processing circuitry configured to, using a trained machine-learning model, map the phoneme to a state using an encoder sub-model of the trained machine-learning model, estimate a second target duration for the phoneme based on the state and determine an attention weight based on the first target duration and the second target duration. The processing circuitry is further configured to map the state to audio data based on the attention weight using a decoder sub-model of the trained machine-learning model, wherein the audio data are indicative of an audio waveform representing speech.

### FIELD

The present disclosure relates to text-to-speech (TTS) synthesis. Examples relate to an apparatus and a method for end-to-end TTS synthesis.

### BACKGROUND

Systems for TTS synthesis aim at generating human-like speech from an input text. However, such systems may suffer from low robustness, e.g., leading to undesired artifacts in the synthetized speech, low quality, e.g., unnatural-sounding speech, complexity of training of an underlying model, or high latency during inference. Hence, there may be a demand for improved TTS synthesis.

### SUMMARY

This demand is met by apparatuses and methods in accordance with the independent claims. Advantageous embodiments are addressed by the dependent claims.

According to a first aspect, the present disclosure relates to an apparatus for end-to-end text-to-speech synthesis. The apparatus comprises input interface circuitry configured to receive first input data indicative of a phoneme and second input data indicative of a first target duration for the phoneme. The apparatus further comprises processing circuitry configured to, using a trained machine-learning model, map the phoneme to a state using an encoder sub-model of the trained machine-learning model, estimate a second target duration for the phoneme based on the state and determine an attention weight based on the first target duration and the second target duration. The processing circuitry is further configured to, using the trained machine-learning model, map the state to audio data based on the attention weight using a decoder sub-model of the trained machine-learning model. The audio data are indicative of an audio waveform representing speech.

According to a second aspect, the present disclosure relates to a method for end-to-end text-to-speech synthesis. The method comprises receiving first input data indicative of a phoneme and receiving second input data indicative of a first target duration for the phoneme. The method further comprises mapping, using a trained machine-learning model, the phoneme to a state using an encoder sub-model of the trained machine-learning model, estimating, using the trained machine-learning model, a second target duration for the phoneme based on the state and determining, using the trained machine-learning model, an attention weight based on the first target duration and the second target duration. The method further comprises mapping, using the trained machine-learning model, the state to audio data based on the attention weight using a decoder sub-model of the trained machine-learning model. The audio data are indicative of an audio waveform representing speech.

### BRIEF DESCRIPTION OF THE FIGURES

Some examples of apparatuses and/or methods will be described in the following by way of example only, and with reference to the accompanying figures, in which

FIG. 1 illustrates an example of an apparatus for end-to-end TTS synthesis;

FIG. 2 illustrates an example of a data flow of data processed by a processing circuitry of an apparatus for end-to-end TTS synthesis;

FIG. 3 illustrates another example of a data flow of data processed by a processing circuitry of an apparatus for end-to-end TTS synthesis;

FIG. 4 illustrates an example of a data flow of a machine-learning algorithm for training a machine-learning model for end-to-end TTS synthesis;

FIG. 5a and FIG. 5b illustrate an example of a second target duration and an example of an attention weight; and

FIG. 6 illustrates a flowchart of an example of a method for end-to-end TTS synthesis.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

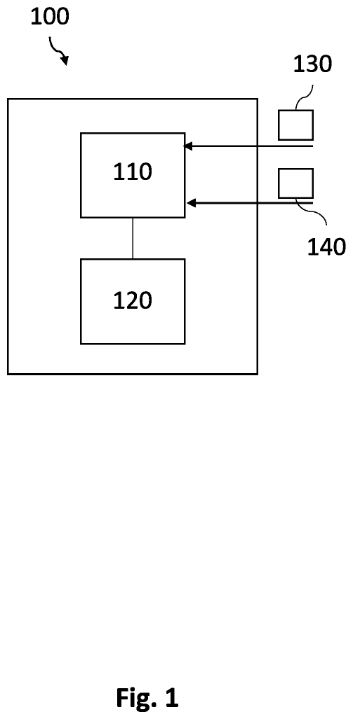

FIG. 1 illustrates an example of an apparatus 100 for end-to-end TTS synthesis. TTS synthesis is the artificial production of speech based on text, e.g., the conversion of a text input into speech output. TTS synthesis may be considered a computer-based imitation of the human reading capability, i.e., a TTS system may be any technology for reproducing-ideally, natural and intelligible sounding-speech corresponding to the text input.

Conventional TTS systems may consist of many models, such as audio segmentation model, phoneme duration prediction model, fundamental frequency prediction model and vocoder model, which are built and trained independently. Unlike conventional TTS systems, end-to-end TTS systems may have a unified framework combining several functional modules for directly—i.e., without intermediate steps-mapping from a text or a phoneme to an audio spectrogram or audio waveform representing speech. End-to-end TTS systems may allow a joint training with a paired data set of text and corresponding speech data with reduced external annotation, thus, they may reduce the complexity of the training of the underlying model and of the deployment pipeline and may avoid error propagation from intermediate steps. In the present case, the apparatus 100 may particularly address “fully” end-to-end-TTS synthesis for directly mapping from a phoneme to an audio waveform, i.e., without an explicit acoustic model.

The apparatus 100 may be, for instance, a computing system or a subpart of a computing system. The computing system may include multiple constituent computing systems. Computing systems may, for example, be handheld devices, appliances, lap-top computers, desk-top computers, mainframes, distributed computer systems, datacenters, cloud server, or wearables.

The apparatus 100 comprises input interface circuitry 110 and processing circuitry 120. For example, the processing circuitry 120 may be a single dedicated processor, a single shared processor, or a plurality of individual processors, some of which or all of which may be shared, a digital signal processor (DSP) hardware, an application specific integrated circuit (ASIC) or a field programmable gate array (FPGA). The processing circuitry 120 may optionally be coupled to, e.g., read only memory (ROM) for storing software, random access memory (RAM) and/or non-volatile memory. The processing circuitry 120 is coupled to the input interface circuitry 110 for transmitting data. The input interface circuitry 110 may implement a software- and/or hardware-based interface between two or more subparts of the apparatus 100 or between the apparatus 100 and an external computing system in order to receive data.

The input interface circuitry 110 is configured to receive first input data 130 indicative of a phoneme. The phoneme may be any phonetic unit which indicates an acoustic representation of a text or a part thereof, e.g., of a word or a syllable. For instance, the phoneme may be a phonetic transcription of the text or a part thereof.

In some examples, the first input data 130 are indicative of a text to be converted into speech. The processing circuitry 120 may be configured to determine the phoneme based on the text. For instance, the processing circuitry 120 may use an algorithm for text analysis and/or linguistic analysis of the text to derive the phoneme from the text. More specifically, the processing circuitry 120 may use any method for grapheme-to-phoneme (G2P) conversion. G2P conversion is the process of generating pronunciation tokens (phonemes) for words based on their spelling (graphemes). For instance, the processing circuitry 120 may use a rule-based method, a hidden Markov model or a neural network for G2P conversion. The processing circuitry 120 may, e.g., map the text to a sequence of phonemes of which one is the phoneme under consideration.

In human speech, a duration of a phoneme, generally, depends on prosody, i.e., on features not necessarily encoded by the phoneme or its grapheme equivalent itself but by larger units of speech or even on features which are context-or speaker-related. An objective of the apparatus 100 may be to model (i.e., estimate or predict) the duration of the phoneme for TTS synthesis with a realistic imitation of human speech. The apparatus 100 may model the duration based on a first target duration and a second target duration, as explained below.

Hereinafter, the first target duration and its optional determination by the processing circuitry 120 are explained in detail:

The input interface circuitry 110 is configured to receive second input data 140 indicative of the first target duration for the phoneme. The first target duration may be, e.g., an estimation of a duration or length of pronunciation of the phoneme, i.e., the first duration may be a time estimate for an acoustic representation of the phoneme. The first target duration may be derived, e.g., from a user input of a user of the apparatus 100 or by an upstream processing of data (e.g., indicative of a video) associated with the phoneme.

For instance, in case the phoneme is determined based on the text or a part thereof, the second input data 140 may be indicative of a stress to be given to the text or the part thereof (for simplification, “the text and the part thereof” may be referred to as “the text”). The stress (or accent) may be a measure for an emphasis or prominence given to the text, in particular, to a certain syllable in a word or to a certain word in a phrase or sentence. For example, the stress may indicate a desired duration (e.g., a vowel length) of parts of the text relative to other parts of the text. A user may have defined the stress, e.g., in form of a user selection or user setting. The user may use a user interface of an electronic device, e.g., comprising the apparatus 100 or being communicatively connected to the apparatus 100, for generating a user input indicating the stress. For instance, the user interface may be a graphical user interface displaying the text. The user may select (e.g., mark or highlight) the parts of the text which are to be stressed (e.g., a difficult technical term in the text) via the graphical user interface and, optionally, define a value of stress intensity. The electronic device may generate the second input data 140 based on the selection of the user.

The processing circuitry 120 may be configured to determine the first target duration based on the stress. For instance, assuming the phoneme is part of a sequence of phonemes, the processing circuitry 120 may determine the first target duration such that it is longer or shorter by a certain value (as indicated by the second input data 140) compared to a (e.g., previously determined or default) duration of another phoneme previous or subsequent to the phoneme under consideration. This may allow an imitation of an effect of prosodic or contrastive stress in human speech. For instance, the processing circuitry 120 may determine the first target duration such that a difficult technical term represented by the phoneme may be read out slower by a TTS system for better intelligibility of the technical term. Alternatively, the processing circuitry 120 may determine, based on the stress, a probability that the first target duration matches a natural audio reproduction of the phoneme. The apparatus 100 may allow modification of a duration for the phoneme based on an external input (i.e., external to the machine-learning model explained below), e.g., a user input. Thus, the apparatus 100 may enable a (user-) controllable determination of the duration which is used for generating an audio waveform for TTS synthesis. The apparatus 100 may, therefore, improve intelligibility, diversity and an impression of naturalness of an output speech of a TTS system.

In some examples, the second input data 140 are indicative of a video depicting a speaking person. The video may be generated based on an optical recording of a scene by a camera. The video may be taken as a basis to, e.g., determine prosody to be given to the phoneme. For instance, the video is intended to be dubbed with speech based on the (input) phoneme, e.g., in case an audio track of the video is missing or shall be replaced, modified or supplemented by synthetized speech. The processing circuitry 120 may be further configured to determine the first target duration based on the video to synchronize the speech to the video, e.g., for aligning a duration of the phoneme to the first target duration derived from the video.

For determining the first target duration, the processing circuitry 120 may be configured to determine a gesture of the speaking person matching the phoneme based on the video. The processing circuitry 120 may, e.g., use any algorithm for gesture recognition for detecting and interpreting the gesture. The processing circuitry 120 may determine and process pixels of the video which are reckoned to be a body, in particular, a face or hand, of the speaking person. Specifically, the processing circuitry 120 may determine a motion, shape or position of the body or parts thereof based on the video and derive the gesture from the motion, shape or position. The processing circuitry 120 may, e.g., track the gesture over several frames of the video and determine therefrom a type, duration or expressiveness of the gesture. The processing circuitry 120 may determine the first target duration based on the determined gesture. For instance, the processing circuitry 120 may match the gesture to the phoneme and derive from the type, duration or expressiveness of the gesture whether and how the phoneme is to be stressed, e.g., whether it is to be “spoken” longer or shorter.

Alternatively, the processing circuitry 120 may be configured to determine the first target duration based on a content of the video. For instance, the processing circuitry 120 may use any algorithm for video analysis for categorizing the content of the video, i.e., the processing circuitry 120 may determine the context of the video. The processing circuitry 120 may determine phonemes to be stressed (e.g., important words according to the context) based on the content.

In some examples, the processing circuitry 120 is configured to determine a second phoneme matching a shape of lips of the speaking person based on the video. The processing circuitry 120 may, e.g., use any algorithm for automated lip reading (speech recognition). For instance, the processing circuitry 120 may determine the shape of lips, extract relevant features from the determined shape, and compare the features to stored features of a “dictionary” linking the features to matching phonemes or text. The processing circuitry 120 may determine the second phoneme based on the said comparison. Alternatively, the processing circuitry 120 may, using a pre-trained lip-reading model (e.g., a deep neural network) for automated lip reading, extract for at least one predefined time frame (e.g., 30 ms) of the video the second phoneme, e.g., which is reckoned as most probably spoken by the speaking person during the predefined time frame. Then, the processing circuitry 120 may determine a correlation between the phoneme and the second phoneme and determine the first target duration based on the correlation. The processing circuitry 120 may, e.g., extract, for a number M of time frames of the video, a sequence S_{V} of second phonemes p, where S_{V}=[p_{V,1}, . . . , p_{V,M}], and determine a correlation between the sequence Sv and a sequence of phonemes S_{g2p}=[p_{g2p,1}, . . . , p_{g2p,N}], where the phoneme under consideration is part of the sequence S_{g2p}. The sequence S_{g2p} may be derived from a text encoded by the first input data 130 based on grapheme-to-phoneme conversion, for instance. N may be the total number of phonemes derived from the text.

The processing circuitry 120 may use any algorithm for determining the above-mentioned correlation, e.g., a statistical relation, between the phoneme and the second phoneme. For instance, the processing circuitry 120 may match the phoneme of the sequence S_{g2p} (of length N) to at least one second phoneme of the sequence S_{V} (of length M). By aligning the two sequences, the first target duration may be inferred from a total duration of the second phoneme (or second phonemes) matching the phoneme of S_{g2p}. More specifically, the total duration may be derived from the time frame(s) the matching second phoneme(s) originate from.

The processing circuitry 120 may use any algorithm for time series analytics to determine the above-mentioned correlation. In some examples, the processing circuitry 120 is configured to determine the correlation based on dynamic time warping (DTW). DTW is a method for calculating a most probable match between two given sequences (such as Sg2p and Sv) based on certain restriction and rules, such as that an index from the one sequence must be matched with one or more indices from the other sequence and vice versa. The most probable match may be denoted by a match that satisfies the restrictions and rules and, additionally, exhibits a minimal cost, where the cost is computed as the sum of absolute differences between respective values of each matched pair of indices, thus, DTW may measure a distance-like quantity between the two sequences. This may be advantageous for determining a measure of correlation between the sequences independently of non-linear variations of the sequences in the time dimension.

Hereafter, it is described how the second target duration is determined and how the first and second target duration are further processed by the processing circuitry 120:

The processing circuitry 120 is configured to, using a trained machine-learning model, map the phoneme to a state using an encoder sub-model of the trained machine-learning model.

The state may be an embedding (e.g., similar to a word embedding of natural language processing), i.e., the state may be a mathematical representation of the phoneme, e.g., in the form of a real-valued vector of a vector space that encodes a feature of the phoneme. The state may be a low-dimensional representation of the phoneme, for instance. The processing circuitry 120 may map the phoneme to the state such that other encoded phonemes that are close to the said state in the vector space are expected to be similar regarding that feature.

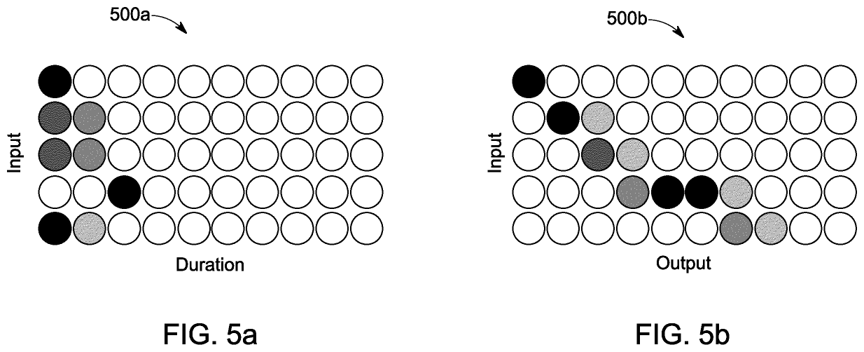

The machine-learning model is a data structure and/or set of rules representing a statistical model that the processing circuitry 120 uses to perform the tasks described herein (e.g., mapping the phoneme to the state) without using explicit instructions, instead relying on models and inference. The data structure and/or set of rules represents learned knowledge (e.g., based on training performed by a machine-learning algorithm). For example, in machine-learning, instead of a rule-based transformation of data, a transformation of data may be used, that is inferred from an analysis of historical and/or training data. In the proposed technique, the content of the first input data 130 is analyzed using the machine-learning model (i.e., a data structure and/or set of rules representing the model). Details about the training of the machine-learning model are explained with reference to FIG. 5.

For example, the machine-learning model may be an Artificial Neural Network (ANN). ANNs are systems that are inspired by biological neural networks, such as can be found in a retina or a brain. ANNs comprise a plurality of interconnected nodes and a plurality of connections, so-called edges, between the nodes. There are usually three types of nodes, input nodes that receive input values (e.g., phonemes), hidden nodes that are (only) connected to other nodes, and output nodes that provide output values (e.g., audio data). Each node may represent an artificial neuron. Each edge may transmit information from one node to another. The output of a node may be defined as a (non-linear) function of its inputs (e.g., of the sum of its inputs). The inputs of a node may be used in the function based on a “weight” of the edge or of the node that provides the input. The weight of nodes and/or of edges may be adjusted in the learning process. In other words, the training of an ANN may comprise adjusting the weights of the nodes and/or edges of the ANN, i.e., to achieve a desired output for a given input.

Alternatively, the machine-learning model may be a support vector machine, a random forest model or a gradient boosting model. Support vector machines (i.e., support vector networks) are supervised learning models with associated learning algorithms that may be used to analyze data (e.g., in classification or regression analysis). Support vector machines may be trained by providing an input with a plurality of training input values (e.g., phonemes) that belong to one of two categories. The support vector machine may be trained to assign a new input value to one of the two categories. Alternatively, the machine-learning model may be a Bayesian network, which is a probabilistic directed acyclic graphical model. A Bayesian network may represent a set of random variables and their conditional dependencies using a directed acyclic graph. Alternatively, the machine-learning model may be based on a genetic algorithm, which is a search algorithm and heuristic technique that mimics the process of natural selection.

The machine-learning model has an encoder-decoder architecture, i.e., the machine-learning model is a modular artificial neural network comprising an encoder sub-model (first module) and a decoder sub-model (second module), which in turn are neural networks themselves. The encoder sub-model may have an input interface for receiving a sequence of phonemes with variable length and may transform (i.e., encode or embed) the sequence into the state which may have a fixed shape or length. The decoder sub-model may map the state to audio data which may have a variable length. The machine-learning model may enable single end-to-end ability for directly mapping from input sequences (phonemes) to output sequences (audio data) and may allow handling of variable length input and output sequences.

The machine-learning model may be any type of neural network, e.g., RNN/RNN (recurrent neural network/recurrent neural network, i.e., the encoder sub-model and the decoder sub-model are RNNs), CNN/CNN (convolutional neural network/convolutional neural network), RNN/CNN, a Seq2Seq (sequence-to-sequence) neural network, or a transformer neural network. In some examples, the machine-learning model may be a combination of the above examples.

In some examples, the machine-learning model may be a parallel model, i.e., it may enable simultaneous computing of several frames of output audio data based on a sequence of input phonemes. For instance, the machine-learning model may replace autoregressive structures of conventional machine-learning model for TTS synthesis by a U-shaped convolutional structure which may be fully parallel. The machine-learning model may infer an alignment relationship between several input phonemes and audio frames at once. The apparatus 100 may, therefore, speed up the generation of audio data based on the phoneme for TTS synthesis.

The processing circuitry 120 is further configured to, using the trained machine-learning model, estimate the second target duration for the phoneme based on the state. The processing circuitry 120 may estimate the second target duration based on a duration model describing a mathematical relation between states and its durations (or duration probabilities). In some examples, the processing circuitry 120 may be configured to estimate the second target duration based on at least one of a differentiable function and a stochastic process. A differentiable function may be considered a mathematical function whose derivative exists at each point in its domain. In other words, the graph of a differentiable function has a non-vertical tangent line at each interior point in its domain. A differentiable function may, therefore, be smooth, i.e., the function is locally well approximated as a linear function at each interior point, and does not contain any break, angle, or cusp. A stochastic (or random) process may be considered a statistical model for describing phenomena that appear to vary in a random manner, such as Markov processes, Lévy processes, Gaussian processes, or random fields.

In a concrete implementation example, it is assumed that the second target duration for the phoneme is a discrete integer in the range of [0, M]. The second target duration may be formulated as a stochastic process. In particular, let wᵢ be a random variable indicating a second target duration of the i-th phoneme and pᵢ∈[0, 1]^{M} be a vector of parameters describing the stochastic distribution of wᵢ, i.e., wᵢ˜P(wᵢ|pᵢ). The probability of having a second target duration of m∈{1, . . . , M} for the i-th phoneme is defined as:

$${l}_{i , m} = {p}_{i , m} {\prod }_{k = 1}^{m - 1} ( 1 - {p}_{i , k} ) = {p}_{i , m} {cumprod ( 1 - {p}_{i , ;} )}_{m - 1} \qquad Equation 1$$

where cumprod(v)=[v₁, v₁v₂, . . . , Πᵢ₌₁^{|v|}vᵢ] is a cumulative product operation. The cumulative product operation of Equation 1 may be computed in the log-space to improve numerical stability for gradient computations. I is referred to as the length probability. Given the parameters pᵢ, the second target duration may be sampled following a sequence of Bernoulli(p_{i,m}) distributions, starting from m=1. As soon as an outcome being one for any m is obtained, the second target duration may be set to m. If no such outcome is computed after M trials, the second target duration may be set to zero with a probability of:

$${l}_{i , 0} = {\prod }_{k = 1}^{M} ( 1 - {p}_{i , k} ) = {cumprod ( 1 - {p}_{i , ;} )}_{M} \qquad Equation 2$$

It can be shown that: Σₘ₌₀^{M}l_{i,m}=1, for every i∈{1, . . . , N}. In other words, the length probability may be considered a valid probability distribution. The second target duration of several phonemes may be obtained by summing over a respective second target duration of each phoneme. Let q_{i,j} denote the probability that a sequence of the first i phonemes having a second target duration of j∈{0, . . . , M}. On the first phoneme, the probability may be identical to the length probability, i.e., q_{1,:}=l_{1.:}. For i>1, q_{i,:} may be recursively formulated by q_{i-1,:} and l_{i,:}, as in the following Equation 3 by considering all possible durations of the i-th phoneme, i.e.:

$${q}_{i , j} = {\sum }_{m = 0}^{j} {q}_{i - 1 , m} {l}_{i , j - 1} \qquad Equation 3$$

The computation of the probability matrix q may be implemented as convolution operation which may enable parallel computing.

The processing circuitry 120 may be further configured to, using the trained machine learning model, determine an attention weight based on the first target duration and the second target duration and map the state to audio data based on the attention weight using the decoder sub-model of the trained machine-learning model. The audio data are indicative of an audio waveform representing speech. The speech may be the TTS output, i.e., the speech may, ideally, be the audio representation of the (input) phoneme.

The machine-learning model is, thus, an attention-based neural network, i.e., the machine-learning model may include any attention mechanism. The attention mechanism is any technique for computationally mimicking cognitive attention. The attention mechanism may be described by an attention function which enhances a weight for some (input) states and diminishes a weight of others. The attention weight may be a “soft” weight, i.e., it may change during runtime since it may depend on a previous output of the machine-learning model. The attention mechanism may be, e.g., a self-attention or a multi-head attention mechanism, an additive or a dot product attention mechanism, a hard or a soft attention mechanism and may be implemented, e.g., by a local or a global neural attention model.

The processing circuitry 120 may, e.g., input the first target duration and the second target duration into an attention model or apply an attention function to the first target duration and the second target duration to determine the attention weight. The attention weight may indicate an attention probability, for instance. The attention weight may be an attention matrix. In some examples, the processing circuitry 120 is configured to determine the attention weight by estimating a probability that the state is aligned with a predefined frame for the audio waveform.

For instance, the processing circuitry 120 may determine the attention weight by determining whether the first target duration or its occurrence probability exceeds a predefined threshold, e.g., for determining whether the first target duration is realistic. For instance, if the first target duration has been derived based on a video using automated lip reading, the second phoneme may, in some cases, be determined with a relative high uncertainty, e.g., when distinguishing which second phoneme occurred in the video (e.g.,/p/or/b/) does not yield an unambiguous result. If the processing circuitry 120 determines that the first target duration or the probability (the uncertainty) exceeds the predefined threshold, the processing circuitry 120 may determine the attention weight solely based on the second target duration.

In yet other examples, the processing circuitry 120 may process the first target duration and the second target duration in any other suitable way for determining the attention weight, e.g., the processing circuitry 120 may determine an intermediate target duration for the phoneme, e.g., based on an average, weighted median or central tendency of the first target duration and the second target duration. The processing circuitry 120 may, then, determine the attention weight based on the intermediate target duration.

In some examples, the processing circuitry 120 is configured to determine a second attention weight based on the second target duration and determine the attention weight by modifying the second attention weight based on the first target duration. In the concrete implementation example described above, the attention weight may be determined as follows, after having determined the second target duration probability of a sequence of phonemes: Let Sij denote the second attention weight being a probability that the j-th output frame (frame of the audio waveform) is aligned with the i-th input token (phoneme). The alignment between h_{i,:} and y_{j.:} may occur when the total second target duration of the first i phonemes is bigger than or equal to j. On the first phoneme, this may be computed as: s_{1,j}=Σₘ₌ⱼ^{M}l_{i,m}. For i>1, s_{i,:} may be computed with q_{i-1,:} and l_{i,:} as:

$${s}_{i , j} = {\sum }_{m = 0}^{j - 1} {q}_{i - 1 , m} {\sum }_{k = j - m}^{M} {l}_{i , k} = {\sum }_{m = 0}^{j - 1} {q}_{i - 1 , m} cumsum * {( {l}_{i , ;} )}_{j - m} \qquad Equation 4$$

where cumsum*(v)=[Σᵢ₌₁^{|v|}vᵢ, Σᵢ₌₂^{|v|}vᵢ, . . . , v_{|v|}] is the reverse cumulative sum operation. Hereby, all possibilities that the i-th phoneme aligns the j-th output frame may be considered. By modeling the second target duration using cumulative summation, the alignment is implicitly enforced to be monotonic. For encouraging discreteness of the output of the duration model, e.g., for “hard alignments” of the phoneme, a zero-mean and unit-variance Gaussian noise may be added to the sigmoid function which produces/. The processing circuitry 120 may, then, modify the second attention weight based on the first target duration.

Note, that the duration model described above may be discarded during inference. For instance, a duration predictor may be used to estimate the second target duration. More concretely, the duration predictor may be trained by taking the state encoding the phoneme as input and the second target duration extracted from the duration model as target.

In some examples, the processing circuitry 120 may be configured to modify the second attention weight based on a limit value for limiting an extent of modification of the second attention weight. In other words, the processing circuitry 120 may only permit modification of the second attention weight within a predefined range (the limit value). This may prevent errors in the determination of the first target duration to over-influence the determination of the attention weight.

Since the attention weight is determined based on the first target duration and the second target duration, the apparatus 100 may allow modification of the attention weight, e.g., for emphasizing a part of a text to be converted to speech or for making parts of the speech longer or shorter. Thus, the apparatus 100 may enable duration control of the speech output and the audio waveform, e.g., for emphasizing words, aligning text, or alike.

It is to be noted that, assuming a sequence of phonemes being input to the apparatus 100, an attention weight for some of the phonemes may be determined based on a respective first target duration and second target duration, as explained above. An attention weight for other phonemes of the sequence may be determined solely based on a respective first target duration or a respective second target duration. For instance, an operation mode of the apparatus 100 may be changed during inference of the audio output such that either the first target duration or the second target duration is discarded for the determination of a respective attention weight for some of the phonemes.

In some examples, the processing circuitry 120 is configured to map the state to the audio data by resampling the state based on the attention weight. For instance, the processing circuitry 120 may up-sample the state by the attention weight. The state may be up-sampled as expected output E[y_{j,:}]=Σᵢ₌₁^{N}s_{i,j}h_{i,:} for j={1, . . . , M}.

The apparatus 100 may provide the possibility to modify the attention probabilities based on a second input (e.g., a user input) to control the speech output for, e.g., modifying the speaking rate, emphasizing words, aligning text and audio waveform. Further, the apparatus 100 may enable resampling of phoneme embeddings by an attention matrix which may be derived from a duration model, e.g., a differentiable duration model. An aligner module of the machine-learning model may output attention probabilities (attention weight), i.e., an alignment between input text and resulting audio waveform. Thereby, the apparatus 100 may align text and audio waveform without external models which need to be separately trained from the machine-learning model.

The apparatus 100 may be useful in several applications, such as in music industry (e.g., changing the rhythm of a TTS output for, e.g., building a rap machine (by emphasizing words) and aligning to the beat of music), in movie industry (e.g., dubbing movie technology for spoken languages which lack an audio source and where the phoneme duration is modulated to make the TTS output lip-synchronous), for controllable speech synthesis (e.g., making synthesized speech to have stressed words, e.g., manually selected by user or using information which comes from video input such as hand gestures or the content of the video, difficult words could be spoken slower such that they are better understandable, e.g., foreign/scientific words), for diverse speech synthesis (e.g., producing diverse speech outputs to avoid artificial speech synthesis which is less boring for a user).

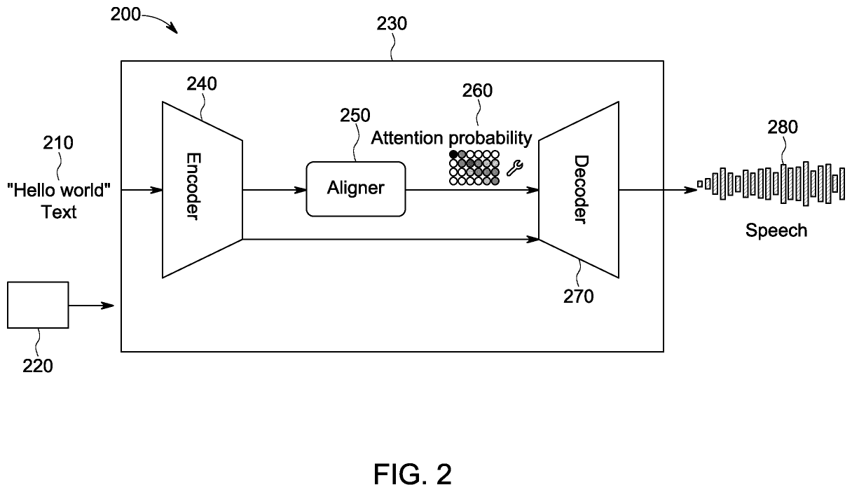

FIG. 2 illustrates an example of a data flow 200 of data processed by a processing circuitry of an apparatus for end-to-end TTS synthesis, such as apparatus 100.

The apparatus comprises input interface circuitry. The input interface circuitry receives first input data 210 indicative of a text (“Hello world”) to be converted into speech. The input interface circuitry provides the first input data 210 or data derived thereof to the processing circuitry. The processing circuitry determines a phoneme based on the text, e.g., using a grapheme-to-phoneme algorithm.

The input interface circuitry further receives second input data 220 indicative of a first target duration for the phoneme. For example, the second input data 220 may be indicative of a stress to be given to the text or parts thereof and the processing circuitry may determine the first target duration based on the stress. The stress to be given to the text or parts thereof may be determined by a user input of a user of the TTS synthesis. Alternatively, the second input data 220 may be indicative of a video depicting a speaking person and the processing circuitry may determine the first target duration based on the video to synchronize the speech to the video. For determining the first target duration, the processing circuitry may determine at least one of a gesture of the speaking person, a content of the video and a second phoneme matching a shape of lips of the speaking person.

The processing circuitry, then, maps the phoneme to a (e.g., hidden) state using an encoder sub-model 240 of a trained machine-learning model 230. The state is output by the encoder sub-model 240 and input to an aligner sub-model 250 of the trained machine-learning model 230. The processing circuitry further estimates a second target duration for the phoneme based on the state using the aligner sub-model 250. The aligner sub-model 250 may model the second target duration based on at least one of a differentiable function and a stochastic process. The second target duration is output by the aligner sub-model 250 and input to an attention mechanism module 260 of the trained machine-learning model 230.

The processing circuitry determines, using the attention mechanism 260, an attention weight based on the first target duration and the second target duration. For instance, the processing circuitry may determine the attention weight by estimating a probability that the state is aligned with a predefined frame for an audio waveform representing the speech. The attention weight may be an attention probability mathematically represented by an attention matrix, for instance. The attention weight is output of the attention weight module 260 and input to a decoder sub-model 270 of the trained machine-learning model 230.

In some examples, the processing circuitry is configured to determine a second attention weight based on the second target duration and determine the attention weight by modifying the second attention weight based on the first target duration. The processing circuitry may be further configured to modify the second attention weight based on a limit value for limiting an extent of modification of the second attention weight.

The processing circuitry maps, using the decoder sub-model 270, the state to audio data 280 based on the attention weight. The audio data 280 are indicative of the audio waveform representing the speech.

In some examples, the processing circuitry is configured to map the state to the audio data 280 by resampling (e.g., up-sampling) the state based on the attention weight. For instance, the encoder sub-model 240 may further input the state to the decoder sub-model 270 which, then, generates second audio data indicative of a raw (i.e., unaligned) audio waveform. The processing circuitry may map the state to the audio data 280 by modifying the raw audio waveform based on the resampled state.

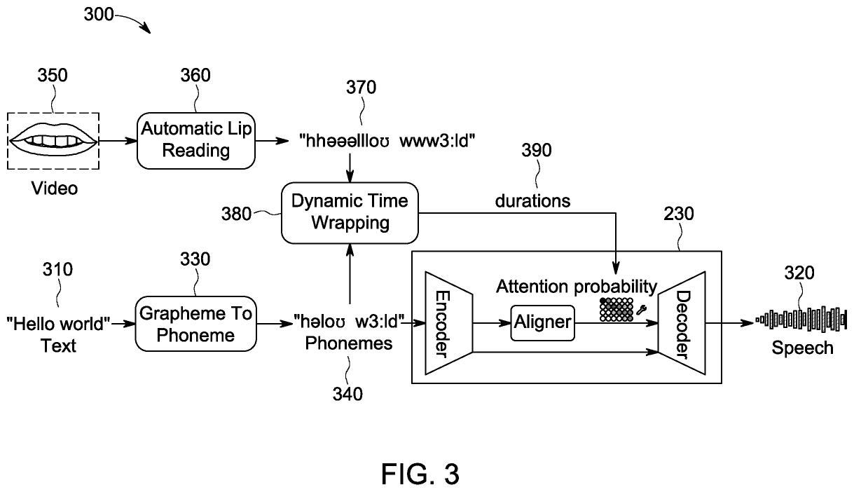

FIG. 3 illustrates another example of a data flow 300 of data processed by a processing circuitry of an apparatus for end-to-end TTS synthesis, such as apparatus 100.

The apparatus comprises input interface circuitry. The input interface circuitry receives first input data 310 indicative of a text (“Hello world”) to be converted into speech, i.e., into audio data 320 indicative of the speech. The first input data 310 is input into a grapheme-to-phoneme module 330. The processing circuitry determines a phoneme 340 based on the text using the grapheme-to-phoneme module 330.

The input interface circuitry further receives second input data 350 indicative of a video depicting a speaking person. In the example of FIG. 3, the video shows the lips of the speaking person. The second input data 350 is input into an automated lip-reading module 360. The processing circuitry further determines, using the automated lip-reading module 360, a second phoneme 370 matching a shape of the lips of the speaking person. The phoneme 340 and the second phoneme 370 are input into a dynamic time warping module 380. The processing circuitry, then, determines a correlation between the phoneme 330 and the second phoneme 370 based on dynamic time warping, i.e., using the dynamic time warping module 380. Further, the processing circuitry determines a first target duration 390 based on the correlation.

The phoneme 340 is also input into a trained machine-learning model 230. The first target duration 390 is input into an attention probability model of the machine-learning model 230. The processing circuitry maps, using the trained machine-learning model 230, the phoneme 340 to a state using an encoder sub-model of the trained machine-learning model 230 and estimate a second target duration for the phoneme 340 based on the state. The processing circuitry determines an attention weight based on the first target duration and the second target duration 390, i.e., using the attention probability module. The processing circuitry, then, maps the state to the audio data 320 based on the attention weight using a decoder sub-model of the trained machine-learning model 230. The audio data 320 are indicative of an audio waveform representing the speech.

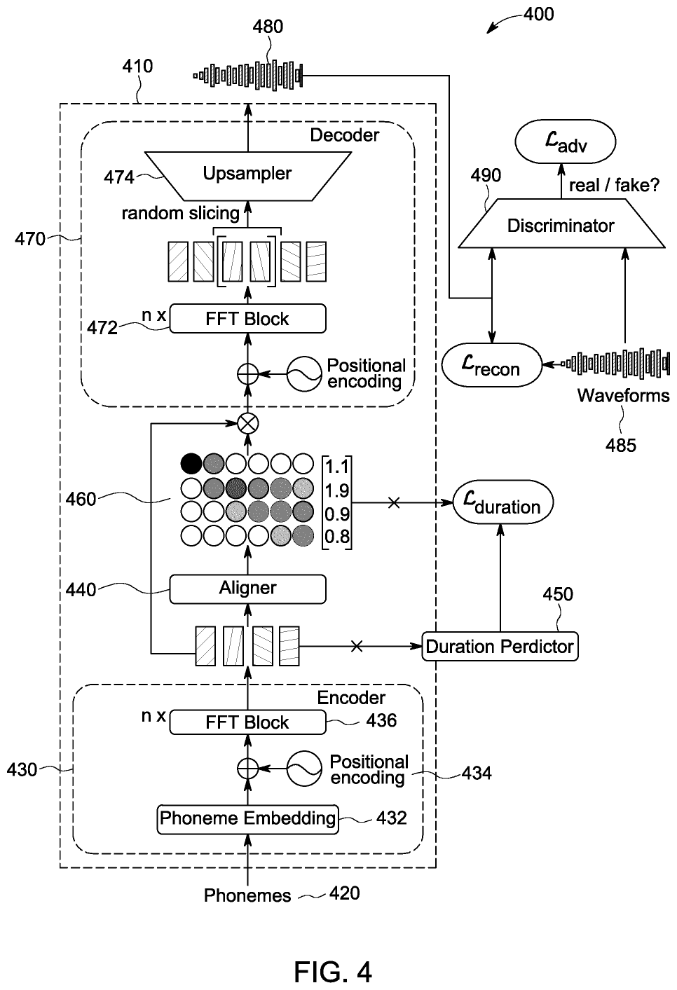

FIG. 4 illustrates an example of a data flow 400 of a machine-learning algorithm for training an example of a machine-learning model 410 for TTS synthesis. An apparatus for end-to-end TTS synthesis disclosed herein, such as apparatus 100, may use the machine-learning model 410—when its training is completed—for generating audio data based on an (input) phoneme.

The term “machine-learning algorithm” denotes a set of instructions that are used to create, train or use a machine-learning model, such as machine-learning model 410. For the machine-learning model 410 to analyze the content of data indicative of phonemes, the machine-learning model 410 may be trained using training and/or historical phonemes as input and training content information (e.g., labels indicating the corresponding audio waveform of the phonemes) as output. By training the machine-learning model 410 with a large set of training phonemes and associated training content information (e.g., labels or annotations), the ma-chine-learning model 410 “learns” to recognize the content of the phonemes, so the content phonemes that are not included in the training data can be recognized using the machine-learning model 410. By training the machine-learning model 410 using training phonemes and a desired output, the machine-learning model “learns” a transformation between the phonemes and the output, which can be used to provide an output based on non-training phonemes provided to the machine-learning model.

The machine-learning model 410 may be trained using training input data (e.g., training phonemes). For example, the machine-learning model 410 may be trained using a training method called “supervised learning”. In supervised learning, the machine-learning model 410 is trained using a plurality of training samples, wherein each sample may comprise a plurality of input data values, and a plurality of desired output values, i.e., each training sample is associated with a desired output value. By specifying both training samples and desired output values, the machine-learning model 410 “learns” which output value to provide based on an input sample that is similar to the samples provided during the training. For example, a training sample may comprise training phonemes as input data and one or more labels as desired output data. The labels indicate a type of the associated audio waveform.

Apart from supervised learning, semi-supervised learning may be used. In semi-supervised learning, some of the training samples lack a corresponding desired output value. Supervised learning may be based on a supervised learning algorithm (e.g., a classification algorithm or a similarity learning algorithm). Classification algorithms may be used as the desired outputs of the trained machine-learning model 410 are restricted to a limited set of values (categorical variables), i.e., the input is classified to one of the limited set of values (type of exercise, execution quality). Similarity learning algorithms are similar to classification algorithms but are based on learning from examples using a similarity function that measures how similar or related two objects are.

Apart from supervised or semi-supervised learning, unsupervised learning may be used to train the machine-learning model 410. In unsupervised learning, (only) input data are supplied and an unsupervised learning algorithm is used to find structure in the input data such as training and/or historical phonemes (e.g., by grouping or clustering the input data, finding commonalities in the data). Clustering is the assignment of input data comprising a plurality of input values into subsets (clusters) so that input values within the same cluster are similar according to one or more (predefined) similarity criteria, while being dissimilar to input values that are included in other clusters.

Reinforcement learning is a third group of machine-learning algorithms. In other words, reinforcement learning may be used to train the machine-learning model 410. In reinforcement learning, one or more software actors (called “software agents”) are trained to take actions in an environment. Based on the taken actions, a reward is calculated. Reinforcement learning is based on training the one or more software agents to choose the actions such that the cumulative reward is increased, leading to software agents that become better at the task they are given (as evidenced by increasing rewards).

Furthermore, additional techniques may be applied to some of the machine-learning algorithms. For example, feature learning may be used. In other words, the machine-learning model 410 may at least partially be trained using feature learning, and/or the machine-learning algorithm may comprise a feature learning component. Feature learning algorithms, which may be called representation learning algorithms, may preserve the information in their input but also transform it in a way that makes it useful, often as a pre-processing step before performing classification or predictions. Feature learning may be based on principal components analysis or cluster analysis, for example.

In some examples, anomaly detection (i.e., outlier detection) may be used, which is aimed at providing an identification of input values that raise suspicions by differing significantly from the majority of input or training data. In other words, the machine-learning model 410 may at least partially be trained using anomaly detection, and/or the machine-learning algorithm may comprise an anomaly detection component.

In some examples, the machine-learning algorithm may use a decision tree as a predictive model. In other words, the machine-learning model 410 may be based on a decision tree. In a decision tree, observations about an item (e.g., a set of input phonemes) may be represented by the branches of the decision tree, and an output value corresponding to the item may be represented by the leaves of the decision tree. Decision trees support discrete values and continuous values as output values. If discrete values are used, the decision tree may be denoted a classification tree, if continuous values are used, the decision tree may be denoted a regression tree.

Association rules are a further technique that may be used in machine-learning algorithms. In other words, the machine-learning model 410 may be based on one or more association rules.

Association rules are created by identifying relationships between variables in large amounts of data. The machine-learning algorithm may identify and/or utilize one or more relational rules that represent the knowledge that is derived from the data. The rules may, e.g., be used to store, manipulate or apply the knowledge.

In the following, an example for training the machine-learning model 410 is explained in detail with reference to FIG. 4: Training input data 420 indicative of a training phoneme sequence are input into the machine-learning model 410. A transformer-based encoder sub-model 412 of the machine-learning model 410 comprises a phoneme embedding layer 432, a positional encoding layer 434 and a Feed-Forward Transformer (FFT) layer 436. The encoder sub-model 412 maps the training phoneme sequence 420 to a state. Therefore, the training input data 420 is input into the phoneme embedding layer 432. The positional encoding layer 434 generates a positional encoding of the training phoneme sequence. The positional encoding may be considered a finite dimensional representation of the location or “position” of phonemes in the training phoneme sequence.

An output of the phoneme embedding layer 432 and the positional encoding are input into the FFT layer 436. The FFT layer 436 may, e.g., comprise a stack of six Feed-Forward Transformer (FFT) blocks. Each FFT block may include self-attention and 1D-convolutional layers of kernel size 9.

The machine-learning model 410 further comprises an aligner module 440, a duration predictor 450 and an attention module 460. The aligner module 440 may comprise three 1D-convolutional layers of kernel size 5 with the ReLU (Rectified Linear Unit) activation, followed by layer normalization and dropout. An output of the FFT layer 436 is input into the aligner module 440 and into the duration predictor 450 for determining a second target duration of the training phoneme sequence. A linear layer may project the (hidden) states into a vector of size M comprising parameters of the distribution that characterizes the second target duration. The duration predictor 460 may be of a similar architecture like that of the aligner module 440, except that a last linear layer of the duration predictor may output a single scalar indicating the second target duration. An output of the aligner module 440 is input into the attention module 460.

Length loss: Based on a length probability of the training phonemes, an expected second target duration of the i-th phoneme may be computed as:

$${E}_{{w}_{i} ∼ P ( {w}_{i} \vert {p}_{i} )} [ {w}_{i} ] = {\sum }_{m = 1}^{M} {ml}_{i , m} \qquad Equation 5$$

An expected length of an entire utterance of the training input data 420 may be computed by summing up the second target durations of the associated phonemes. The expected length may be encouraged to be close to the ground truth length M of the speech by minimizing the following loss:

$${L}_{length} = \frac{1}{N} \vert M - {\sum }_{i = 1}^{N} {E}_{{w}_{i} ∼ P ( {w}_{i} \vert {p}_{i} )} [ {w}_{i} ] \vert \qquad Equation 6$$

Duration loss: The duration predictor 460 may be used to estimate the second target durations of the phonemes. This may speed up inference. More concretely, the duration predictor 460 takes phoneme hidden sequences hᵢ as inputs and second target durations extracted from the aligner module 440 as targets. During training, a gradients propagation from the duration predictor 460 to the encoder sub-model 430 and the aligner module 440 may be stopped. Our duration loss may be summarized as:

$${L}_{duration} = \frac{1}{N} {\sum }_{i = 1}^{N} \vert f ( sg [ {h}_{i} ] - sg [ {E}_{{w}_{i} ∼ P ( {w}_{i} \vert {p}_{i} )} [ {w}_{i} ] ] \vert \qquad Equation 7$$

where sg[⋅] indicates a stop gradient operator. During inference, the aligner module 440 may be discarded and the duration predictor 460 may be used for synthesizing speech.

An output of the attention module 460 is input into a decoder sub-model 470 of the machine-learning model 410. The decoder sub-model 470 comprises an FFT layer 472 and an Up-sampler network 474. For instance, the FFT layer 472 may comprise two FFT blocks. The decoder sub-model 470 may aim at up-sampling the output sequence of the aligner model 440 to match the temporal resolution of the raw (output) audio waveform. The up-sampler network 474 may be a fully convolutional neural network. The up-sampler network 474 outputs audio data 480 indicative of an audio waveform representing speech.

The machine-learning model 410 is trained based on adversarial learning. The (synthetized) audio data 480 and training output data 485 are input into a discriminator 490. The discriminator 490 may comprise several multi-period discriminators and multi-scale discriminators operating on different resolutions of its input.

The training output data 485 are indicative of a training audio waveform. The training output data 485 and the training input data 420 are jointly recorded data, i.e., the training audio waveform is a sounded version of the phonemes of the training input data 420. The discriminator 490 is used to distinguish between the training audio waveform and the synthetized audio waveform produced by the machine-learning model 410.

In particular, the following loss function may used be to train the machine-learning model 410:

$$L = {L}_{adv - G} + {λ}_{length} {L}_{length} + {λ}_{duration} {L}_{duration} + {λ}_{recon} {L}_{recon} \qquad Equation 8$$

where L_{adv-G}, L_{length}, L_{duration}, and L_{recon} indicate the adversarial, length, duration, and reconstruction losses, respectively and where λ_{length}, λ_{duration}, and λ_{recon} are associated weights. The discriminator 490 may be simultaneously trained using an adversarial loss L_{adv-D}.

The details of each loss function are described in the following:

Adversarial loss: The least-squares loss is employed for adversarial training, i.e.,

$$\begin{matrix}{L}_{adv - D} = {E}_{( x , z )} [ {( D ( z ) - 1 )}^{2} + {D ( G ( x ) )}^{2} ] \\ {L}_{adv - G} = {E}_{x} [ ( {D ( G ( x ) - 1 )}^{2} ]\end{matrix} \qquad Equation 9$$

On one hand, the discriminator 490 may force the output of real samples to be one and that of synthesized samples to be zero. On the other hand, a generator may be trained to fool the discriminator 490 by producing samples that are classified as real samples. This training scheme may help to synthesize realistic speech.

Reconstruction loss: Given a sequence of phonemes, the machine-learning model 410 may reconstruct the corresponding speech. To this end, the feature matching loss and the spectral loss may be adopted. In particular, the synthesized speech may be forced to be as similar as the real speech by minimizing:

$${L}_{recon} = {E}_{( x , z )} [ {‖ {D}^{t} ( G ( x ) ) - {D}^{t} ( z ) ‖}_{1} ] + {λ}_{mel} {E}_{( x , z )} [ {‖ ϕ ( G ( x ) ) - ϕ ( z ) ‖}_{1} ] \qquad Equation 10$$

where D^{t} is a feature map output of the discriminator 490 at the t-th layer, ϕ is a log-magnitude of a mel-spectrogram, and λₘₑₗ is a weight.

The machine-learning model 410 may enable a differentiable duration method for learning monotonic alignments between input and output sequences. The machine-learning model 410 may be based on a soft duration mechanism that optimized a stochastic process in expectation. Furthermore, it may improve direct (end-to-end) text-to-waveform synthesis for producing raw audio waveform as output. Therefore, the machine-learning model 410 may circumvent the implementation of neural vocoding.

FIG. 5a and FIG. 5b illustrate an example of a second target duration 500a and an example of an associated attention weight 500b, respectively. An apparatus for end-to-end TTS synthesis, such as apparatus 100 may estimate the second target duration 500a for at least one (input) phoneme based on a state, as described above. The apparatus may determine the attention weight 500b based on a first target duration and the second target duration 500a, as described above.

The second target duration 500a and the attention weight 500b are both matrices comprising probabilities of a distinct second target duration or attention weight, respectively, to be true. Elements of the matrices are represented by dots in FIG. 5a and FIG. 5b. The probabilities are illustrated as shading on a grey scale in, i.e., the darker the grey of a dot, the higher the probability of the associated matrix element.

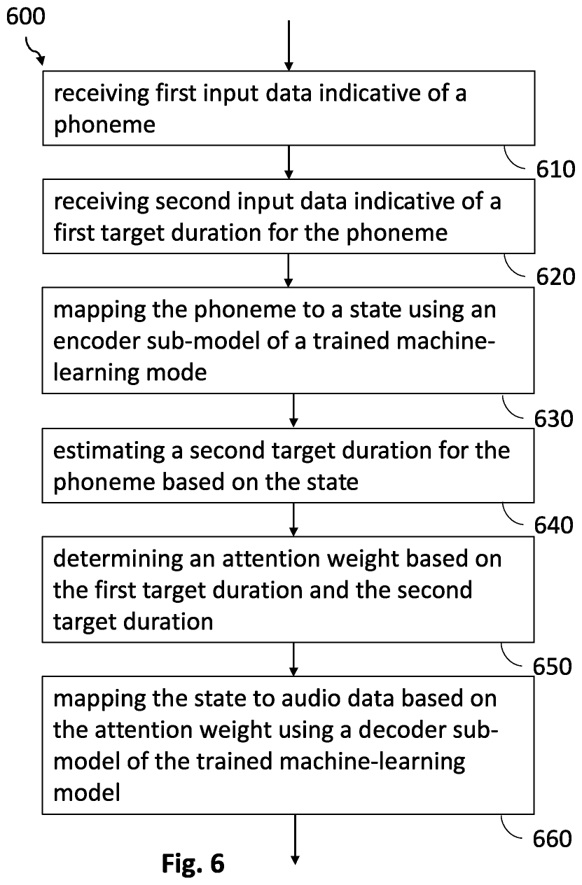

FIG. 6 illustrates a flowchart of an example of a method 600 for end-to-end TTS synthesis. The method 600 comprises receiving 610 first input data indicative of a phoneme, receiving 620 second input data indicative of a first target duration for the phoneme and mapping 630, using a trained machine-learning model, the phoneme to a state using an encoder sub-model of the trained machine-learning model. The method 600 further comprises estimating 640, using the trained machine-learning model, a second target duration for the phoneme based on the state, determining 650, using the trained machine-learning model, an attention weight based on the first target duration and the second target duration and mapping 660, using the trained machine-learning model, the state to audio data based on the attention weight using a decoder sub-model of the trained machine-learning model. The audio data are indicative of an audio waveform representing speech.

More details and aspects of the method 600 are explained in connection with the proposed technique or one or more examples described above, e.g., with reference to FIG. 1. The method 600 may comprise one or more additional optional features corresponding to one or more aspects of the proposed technique, or one or more examples described above.

Apparatuses and method disclosed herein may provide the possibility to modify an attention probability of a TTS model based on a second input (e.g., a user input) to control a speech output for, e.g., modifying the speaking rate, emphasizing words, aligning text and audio waveform. Further, the apparatuses and methods may enable resampling of phoneme embeddings by an attention weight which may be derived from a duration model, e.g., a differentiable duration model. The apparatuses and methods may simplify a training of the TTS model as they allow back-propagation of gradients through the entire model. Moreover, they may improve the perceptual audio quality of the (output) audio data by leveraging adversarial training in an end-to-end fashion.

The following examples pertain to further embodiments:
(1) An apparatus for end-to-end text-to-speech synthesis, comprising:
input interface circuitry configured to receive:
first input data indicative of a phoneme; and
second input data indicative of a first target duration for the phoneme;
processing circuitry configured to, using a trained machine-learning model:
map the phoneme to a state using an encoder sub-model of the trained machine-learning model;
estimate a second target duration for the phoneme based on the state;
determine an attention weight based on the first target duration and the second target duration; and
map the state to audio data based on the attention weight using a decoder sub-model of the trained machine-learning model, wherein the audio data are indicative of an audio waveform representing speech.
(2) The apparatus of (1), wherein the first input data are indicative of a text to be converted into the speech, and wherein the processing circuitry is further configured to determine the phoneme based on the text.
(3) The apparatus of (2), wherein the second input data are indicative of a stress to be given to the text or parts thereof, wherein the processing circuitry is further configured to determine the first target duration based on the stress.
(4) The apparatus of (1) or (2), wherein the second input data are indicative of a video depicting a speaking person, and wherein the processing circuitry is further configured to determine the first target duration based on the video to synchronize the speech to the video.
(5) The apparatus of (4), wherein, for determining the first target duration, the processing circuitry is configured to determine a gesture of the speaking person matching the phoneme based on the video and determine the first target duration based on the determined gesture.
(6) The apparatus of (4) or (5), wherein the processing circuitry is configured to determine a second phoneme matching a shape of lips of the speaking person based on the video, determine a correlation between the phoneme and the second phoneme and determine the first target duration based on the correlation.
(7) The apparatus of (6), wherein the processing circuitry is configured to determine the correlation based on dynamic time warping.
(8) The apparatus of any one of (1) to (7), wherein the processing circuitry is configured to estimate the second target duration based on at least one of a differentiable function and a stochastic process.
(9) The apparatus of any one of (1) to (8), wherein the processing circuitry is configured to map the state to the audio data by resampling the state based on the attention weight.
(10) The apparatus of any one of (1) to (9), wherein the processing circuitry is configured to determine the attention weight by estimating a probability that the state is aligned with a predefined frame for the audio waveform.
(11) The apparatus of any one of (1) to (10), wherein the processing circuitry is configured to determine a second attention weight based on the second target duration and determine the attention weight by modifying the second attention weight based on the first target duration.
(12) The apparatus of (11), wherein the processing circuitry is configured to modify the second attention weight based on a limit value for limiting an extent of modification of the second attention weight.
(13) A method for end-to-end text-to-speech synthesis, comprising:
receiving first input data indicative of a phoneme;
receiving second input data indicative of a first target duration for the phoneme;
mapping, using a trained machine-learning model, the phoneme to a state using an encoder sub-model of the trained machine-learning model;
estimating, using the trained machine-learning model, a second target duration for the phoneme based on the state;
determining, using the trained machine-learning model, an attention weight based on the first target duration and the second target duration; and
mapping, using the trained machine-learning model, the state to audio data based on the attention weight using a decoder sub-model of the trained machine-learning model, wherein the audio data are indicative of an audio waveform representing speech.
(14) A non-transitory machine-readable medium having stored thereon a program having a program code for performing the method of (13), when the program is executed on a processor or a programmable hardware.
(15) A program having a program code for performing the method of (13), when the program is executed on a processor or a programmable hardware.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps,-functions,-processes or-operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for end-to-end text-to-speech synthesis, comprising:
input interface circuitry configured to receive:
first input data indicative of a phoneme; and
second input data indicative of a first target duration for the phoneme;
processing circuitry configured to, using a trained machine-learning model:
map the phoneme to a state using an encoder sub-model of the trained machine-learning model;
estimate a second target duration for the phoneme based on the state;
determine an attention weight based on the first target duration and the second target duration; and
map the state to audio data based on the attention weight using a decoder sub-model of the trained machine-learning model, wherein the audio data are indicative of an audio waveform representing speech.

2. The apparatus of claim 1, wherein the first input data are indicative of a text to be converted into the speech, and wherein the processing circuitry is further configured to determine the phoneme based on the text.

3. The apparatus of claim 2, wherein the second input data are indicative of a stress to be given to the text or parts thereof, wherein the processing circuitry is further configured to determine the first target duration based on the stress.

4. The apparatus of claim 1, wherein the second input data are indicative of a video depicting a speaking person, and wherein the processing circuitry is further configured to determine the first target duration based on the video to synchronize the speech to the video.

5. The apparatus of claim 4, wherein, for determining the first target duration, the processing circuitry is configured to:
determine a gesture of the speaking person matching the phoneme based on the video; and
determine the first target duration based on the determined gesture.

6. The apparatus of claim 4 wherein the processing circuitry is configured to:
determine a second phoneme matching a shape of lips of the speaking person based on the video;
determine a correlation between the phoneme and the second phoneme; and
determine the first target duration based on the correlation.

7. The apparatus of claim 6, wherein the processing circuitry is configured to determine the correlation based on dynamic time warping.

8. The apparatus of claim 1, wherein the processing circuitry is configured to estimate the second target duration based on at least one of a differentiable function and a stochastic process.

9. The apparatus of claim 1, wherein the processing circuitry is configured to map the state to the audio data by resampling the state based on the attention weight.

10. The apparatus of claim 1, wherein the processing circuitry is configured to determine the attention weight by estimating a probability that the state is aligned with a predefined frame for the audio waveform.

11. The apparatus of claim 1, wherein the processing circuitry is configured to determine a second attention weight based on the second target duration and determine the attention weight by modifying the second attention weight based on the first target duration.

12. The apparatus of claim 11, wherein the processing circuitry is configured to modify the second attention weight based on a limit value for limiting an extent of modification of the second attention weight.

13. A method for end-to-end text-to-speech synthesis, comprising:
receiving first input data indicative of a phoneme;
receiving second input data indicative of a first target duration for the phoneme;
mapping, using a trained machine-learning model, the phoneme to a state using an encoder sub-model of the trained machine-learning model;
estimating, using the trained machine-learning model, a second target duration for the phoneme based on the state;
determining, using the trained machine-learning model, an attention weight based on the first target duration and the second target duration; and
mapping, using the trained machine-learning model, the state to audio data based on the attention weight using a decoder sub-model of the trained machine-learning model, wherein the audio data are indicative of an audio waveform representing speech.

14. A non-transitory machine-readable medium having stored thereon a program having a program code for performing the method of claim 13, when the program is executed on a processor or a programmable hardware.

15. A program having a program code for performing the method of claim 13, when the program is executed on a processor or a programmable hardware.
